(19) United States
(12) Patent Application Publication
(10) Pub. No.: US 2013/0148822 A1
(43) Pub. Date: Jun. 13, 2013

(54) Correcting Non-Linear Loudspeaker Response

(71) Applicant: Sontia Logic Limited, Sheffield (GB)

(72) Inventors: Alan Bithell, Sheffield (GB); James Hedges, Sheffield (GB); Weiming Li, Sheffield (GB); Christopher Vernon, Beverley (GB)

(73) Assignee: SONTIA LOGIC LIMITED, Sheffield (GB)

(21) Appl. No.: 13/708,549

(22) Filed: Dec. 7, 2012

(30) Foreign Application Priority Data
Dec. 8, 2011 (GB) 11 21 075.4

(51) Int. Cl. H04R 3/04

(52) U.S. Cl. 381/97

(57) ABSTRACT

The invention relates to processing an audio signal to correct the non-linear frequency response of a loudspeaker. An input audio stream (1801) is received, from which an input frame (1802) is generated. The input frame is subjected to a Fourier transform thereby creating a frequency spectrum defining magnitude and phase values for a plurality of frequency bands. The frequency spectrum is adjusted by scaling the magnitude and phase values of each of the plurality of frequency bands by a magnitude and phase correction coefficient. Dither may be added. An output frame (1806) is then created by performing an inverse Fourier transform on the frequency spectrum, so as to create a portion of an output audio stream (1809).

### CROSS REFERENCE TO RELATED APPLICATIONS

This application claims priority from United Kingdom patent application number 11 21 075.4 filed Dec. 8, 2011, whose contents are incorporated herein by reference in their entirety.

### BACKGROUND OF THE INVENTION

1. Field of the Invention

This invention relates to a method of processing an audio signal to correct the non-linear frequency response of a loudspeaker. The invention also relates to an apparatus for correcting the anticipated distortion of an audio signal by a loudspeaker having a non-linear frequency response.

2. Description of the Related Art

It is well known that loudspeakers exhibit a non-linear response in terms of the sensitivity to signals of differing frequencies. This issue has plagued audio system designers for many years. In addition, the phase response of loudspeakers is highly non-linear, in that shifts in phase occur a differing degrees depending upon frequency. Previous attempts to correct these issues have been less than successful, even with the availability of high-performance digital signal processors.

Further, the bandwidth of loudspeaker drivers is limited, in that a loudspeaker drive unit is only capable of reproducing frequencies within a certain range at a reasonably constant level of sensitivity. This can prove troublesome in loudspeaker designs only employing one wide-band driver, as there is a trade-off in terms of frequency response of the loudspeaker in order to reduce costs by only using a single driver.

Not only are non-linearities present in the first place, but the problem is compounded by the fact that the sensitivity and phase response of a loudspeaker is dependent upon the gain applied by an amplifier to an audio signal—often referred to as the volume level.

### BRIEF SUMMARY OF THE INVENTION

According to a first aspect of the present invention, there is provided a method of processing an audio signal to correct the non-linear frequency response of a loudspeaker, the method comprising steps of: receiving an audio signal as an input audio stream comprising digital samples; generating an input frame from the input audio stream, comprising a plurality of said digital samples; performing a Fourier transform on the input frame, thereby creating a frequency spectrum defining magnitude and phase values for a plurality of frequency bands; adjusting the frequency spectrum by scaling the magnitude and phase values of each of the plurality of frequency bands by a magnitude and phase correction coefficient; performing an inverse Fourier transform on the adjusted frequency spectrum to create an output frame; outputting the output frame as part of an output audio stream.

According to a second aspect of the present invention, there is provided a method of correcting the anticipated distortion of an audio signal by a loudspeaker having a non-linear frequency response, the method comprising steps of: receiving an input audio stream, representing an input audio signal; generating a frequency spectrum of at least a portion of the input audio stream, wherein the frequency spectrum defines respective magnitude and phase values for each of a plurality of frequency bands; for at least one of the plurality of frequency bands, adjusting the magnitude and the phase values of the frequency band to counteract the effect of the non-linear frequency response of the loudspeaker to signals in that frequency band.

According to a third aspect of the present invention, there is provided an apparatus for correcting the anticipated distortion of an audio signal by a loudspeaker having a non-linear frequency response, the apparatus comprising: an input frame generator, configured to receive an input audio stream comprising digital samples and generate input frames each comprising a plurality of samples; a Fourier transform processor configured to subject each of said input frames to a Fourier transform, thereby creating frequency spectra of the input frames, each frequency spectrum defining the magnitude and phase values of each of a plurality of frequency bands; a storage device having stored therein a set of magnitude and phase correction coefficients, each one of which corresponds to one of the plurality of frequency bands; a multiplier configured to scale the magnitude and phase values of each frequency band in each of the frequency spectra by the corresponding magnitude and phase correction coefficient; an inverse Fourier transform processor configured to perform an inverse Fourier transform on the output of the multiplier to create output frames; and an output frame combiner configured to combine said output frames to generate an output audio stream.

### BRIEF DESCRIPTION OF THE DRAWINGS

FIG. 1 shows an environment particularly suitable for applying the principles of the present invention;

FIG. 2 shows a generic overview of components used for audio reproduction within each of the devices illustrated in FIG. 1;

FIG. 3 shows an exemplary test environment for determining the sensitivity of a loudspeaker in an audio reproduction system;

FIG. 4 shows an overview of procedures undertaken to characterise the sensitivity of a loudspeaker in a device under test;

FIG. 5 shows the results of the analysis of a loudspeaker's frequency response following the procedures of FIG. 4;

FIG. 6 shows the process of analysing a full set of stored signals recording the sensitivity of the loudspeaker in a device under test;

FIG. 7 shows a set of magnitude scaling values created by the process illustrated in FIG. 6;

FIG. 8 shows an exemplary test arrangement for determining the phase response of a device;

FIG. 9 shows an overview of procedures undertaken to characterise the phase response of a device under test in the environment illustrated in FIG. 8;

FIG. 10 shows the results of the analysis of a device under test's phase response following the procedures of FIG. 9;

FIG. 11 shows the process of analysing a full set of stored signals recording the phase response of a device under test;

FIG. 12 shows a set of phase shift values created by the process illustrated in FIG. 11;

FIG. 13 shows the process of creating magnitude and phase correction coefficients;

FIG. 14 shows an exemplary configuration of a signal processor;

FIG. 15 shows digital signal processing modules employed by the present invention;

FIG. 16 shows procedures carried out in a first mode of operation by the signal processor;

FIG. 17 shows procedures carried out in a second mode of operation by the signal processor; and

FIG. 18 shows a high-level graphical representation of the processing of a number of input frames derived from an input audio stream.

### DETAILED DESCRIPTION OF EXAMPLE EMBODIMENTS

### Overview of the Invention

At a high level, the present invention corrects the anticipated distortion of an audio signal due to the non-linear frequency response of a loudspeaker. As will become apparent to those skilled in the art, the techniques employed by the present invention are applicable across a wide range of audio reproduction devices.

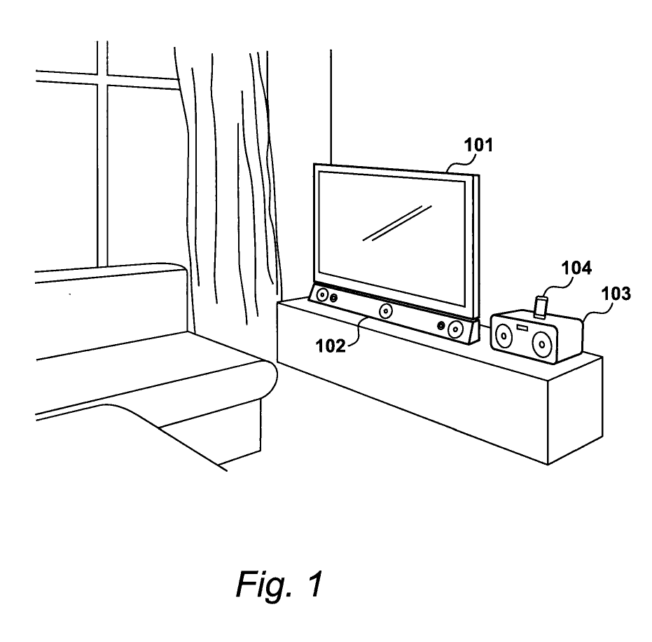

### FIG. 1

An environment particularly suitable for applying the principles of the present invention is illustrated in FIG. 1.

As shown in the Figure, a room contains a television 101, a sound bar 102 and a small stereo system 103. Stereo system 103 is adapted to be a “dock” for a personal music player 104. Each one of the systems illustrated is capable of audio reproduction by means of internal loudspeakers. Typically, each system employs two loudspeaker drive units—one being for reproducing a left channel of audio and another for reproducing a right channel of audio, thus enabling stereo reproduction. In each one of the devices illustrated in FIG. 1, there has been a trade-off in terms of loudspeaker quality to enable high-quality industrial design at reasonable costs. Thus, the systems would not tend to be classed as offering reference design level audio reproduction.

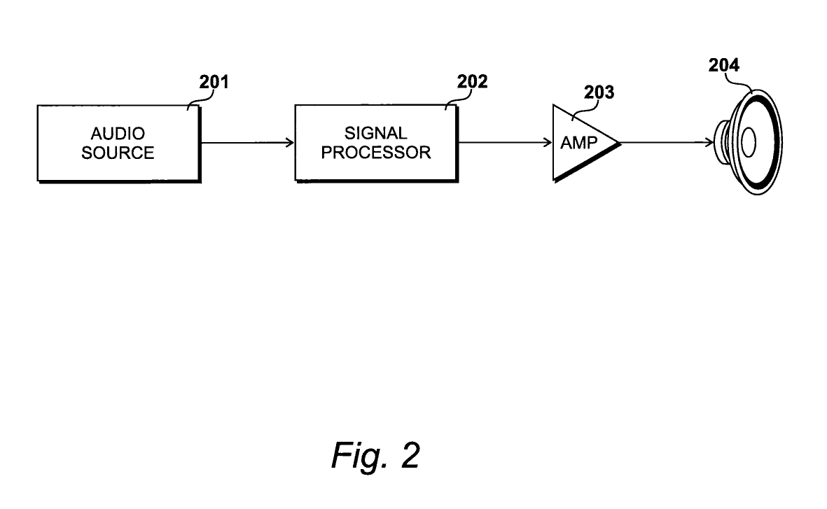

### FIG. 2

A generic overview of components used for audio reproduction within each of the devices illustrated in FIG. 1, is shown in FIG. 2.

An audio source 201 is provided, which in the case of a television could be the television signal decoder, or in the case of a stereo system could be a compact disc or another source, such as personal music player 104. Audio source 201 provides an input audio signal to a signal processor 202, which provides a degree of processing to the signal. The input audio signal may either be analogue or digital, depending upon the embodiment.

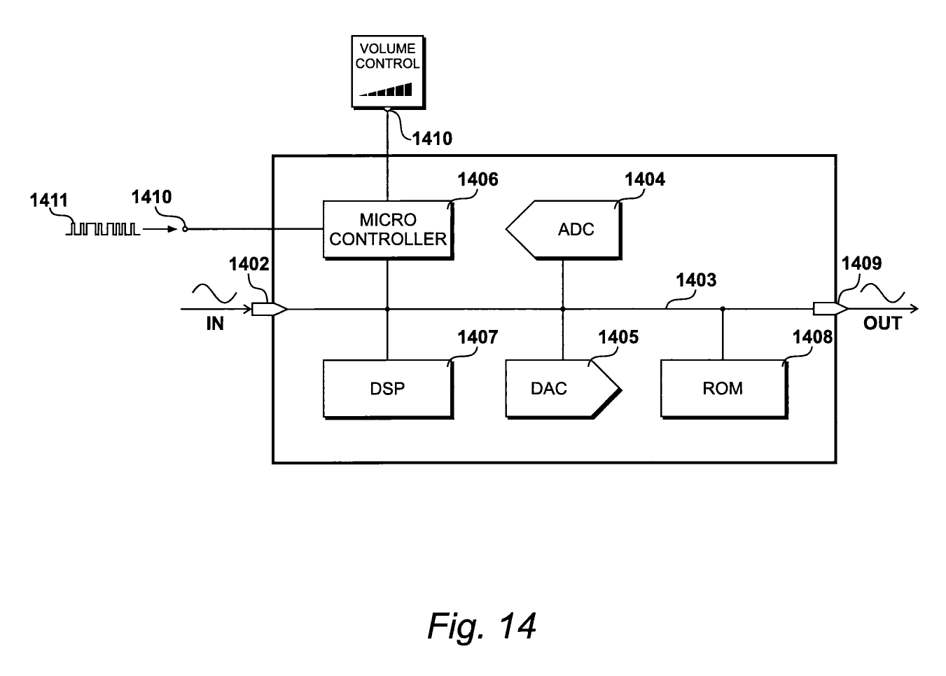

Following processing of the input audio signal, an output audio signal is provided to an amplifier 203, which is configured to amplify the output audio signal and provide it to a loudspeaker 204. The amplifier 203 is, in one embodiment, a switching amplifier (also known as a Class D amplifier) configured to receive and amplify a high sample-rate digital signal. In another embodiment, amplifier 203 is an analogue amplifier, operating in Class A, Class B or Class A/B mode, and is therefore configured to receive an analogue signal for amplification. As will be described later with reference to FIG. 14, signal processor 202 is configured to cater for both possible types of amplifier.

Loudspeaker 204 is responsible for reproducing one channel of audio, and so, as described previously, there will be another present for the purposes of reproducing another channel of a stereo signal. In the context of the present invention, loudspeaker 204 comprises one single wide-band drive unit.

The present applicant has appreciated that a degree of signal processing capability is present in many of the systems that include a loudspeaker that has a non-linear frequency response. Thus, the present invention seeks to utilise this capability in a technical approach to overcoming this problem. By processing the input audio signal from audio source 201 by altering its properties in the frequency domain, it is possible to smoothen the frequency response, allowing both more precise response and improved bandwidth

### Device Characterisation

This description now turns to the manner in which a system including loudspeaker can be characterised and a suitable set of correction values derived so as to cancel non-linearities and the distortions they introduce. An analytical approach to creating a processing algorithm to reduce non-linearities would be difficult due to the inherent complexities in modelling the interaction between each and every component within a device that can contribute to distortion. Thus, the present invention employs empirical characterisation of a device to achieve its aims.

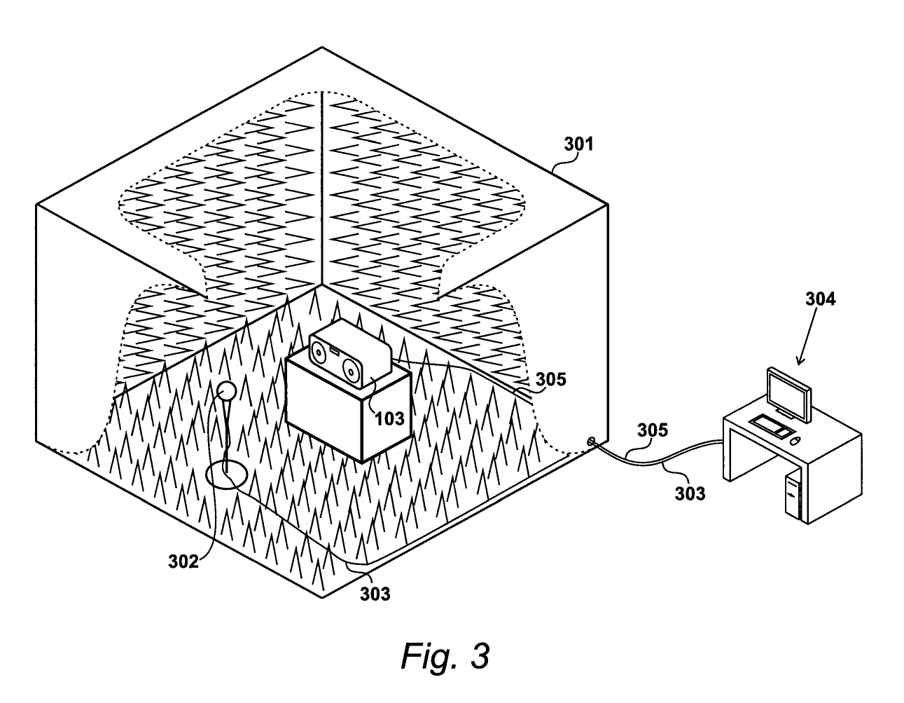

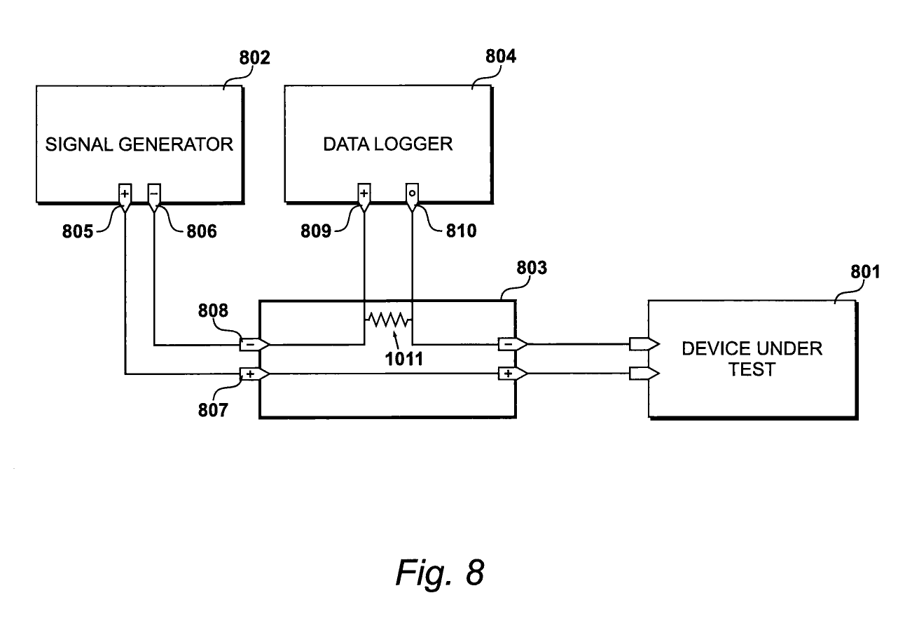

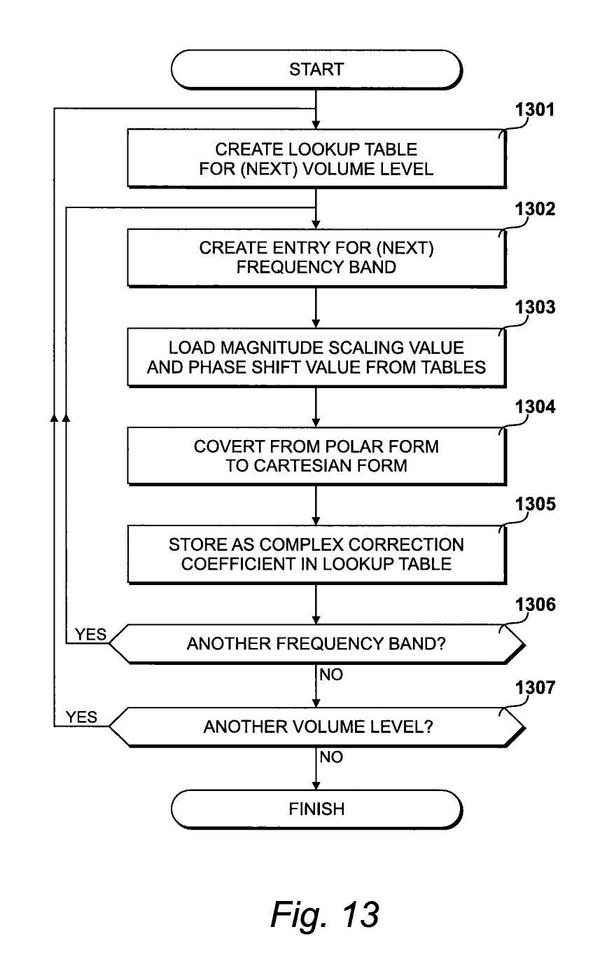

As mentioned previously, non-linearities occur in terms of a loudspeaker's sensitivity at different frequencies, thus requiring a correction to be made in terms of the magnitude of different frequency components in an audio signal, and also in terms of phase shifts at different frequencies, thus requiring a correction to be made in terms of the phase of different frequency components. A procedure for deriving magnitude correction values is discussed with reference to FIGS. 3 to 7, whilst a procedure for creating phase correction values is discussed with reference to FIGS. 8 to 12. The creation of a magnitude and phase correction coefficient is described with reference to FIG. 13.

### FIG. 3

An exemplary test environment for determining the sensitivity of a loudspeaker in an audio reproduction system is illustrated in FIG. 3.

A device under test, which is in this example stereo system 103, is shown placed in a substantially anechoic chamber 301. Alternatively, the device under test can be placed in a characterised space or a “known room”, that is to say a space that has been characterised and thus has a known transfer function which can be used to deconvolve a test signal and recover a substantially identical signal to that obtained in an anechoic chamber.

A microphone 302 is placed at a notional listening position within the anechoic chamber, and is connected via a cable 303 to a computer workstation 304 outside the anechoic chamber. The device under test, in this case stereo system 103, is also connected to computer workstation 304 via another cable 305. Thus, in this example, under the control of computer workstation 304, stereo system 103 is supplied with at least one test signal comprising a plurality of frequencies in a frequency sweep. Stereo system 103 then reproduces the signal, and the resultant sound is detected by microphone 302. The output of microphone 302 is then received by computer workstation 304, whereupon it is processed.

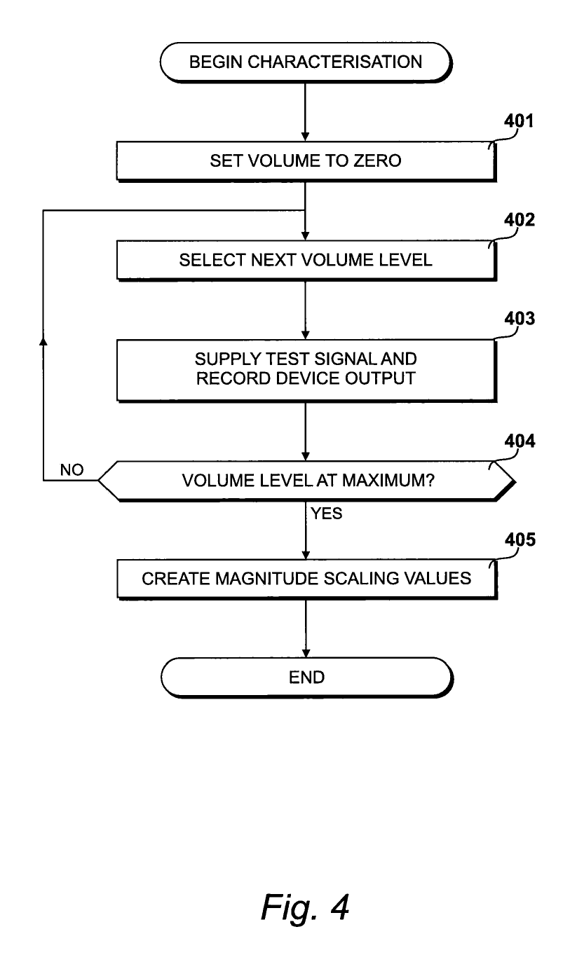

The procedure of testing a candidate audio reproduction device, such as television 101, sound bar 102 or stereo system 103 for non-linear frequency response will be described in further detail with reference to FIGS. 4 to 9.

### FIG. 4

An overview of procedures undertaken to characterise the sensitivity of a loudspeaker in a device under test in the environment illustrated in FIG. 3, is shown in FIG. 4.

The characterisation process begins, and at step 401 the volume level of the device under test is set to zero. At step 402, a loop begins in which the next volume level is firstly selected. In the context of the present invention, the volume setting of a device under test will be understood by those skilled in the art to mean the gain (or attenuation, if viewed from another perspective) of the input audio signal when being amplified. In one example, every possible volume level that a device may be set to is used during the characterisation process. Alternatively, only a subset of every possible volume level is tested.

At step 403, a test signal is supplied to the device, at which time the output of the device is recorded using microphone 302. In an embodiment, the test signal supplied to the device is a sinusoidal frequency sweep. Such a frequency sweep is composed of a sequence of discrete sinusoids, with each having a greater frequency than the previous. In an embodiment, the frequency increases in increments of 1 hertz, from a base frequency of 20 hertz to a maximum of 20 kilohertz. In a specific embodiment, the frequencies of the frequency sweep have a common fixed amplitude. It is found that accuracy is improved by supplying a test signal in which a single frequency is produced at a time, as opposed to an alternative technique in which many frequencies are generated in a burst or click of noise.

Thus, the result of performing step 403 is a recording of the device under test's frequency response in terms of the magnitude of a plurality of frequencies at a particular volume level.

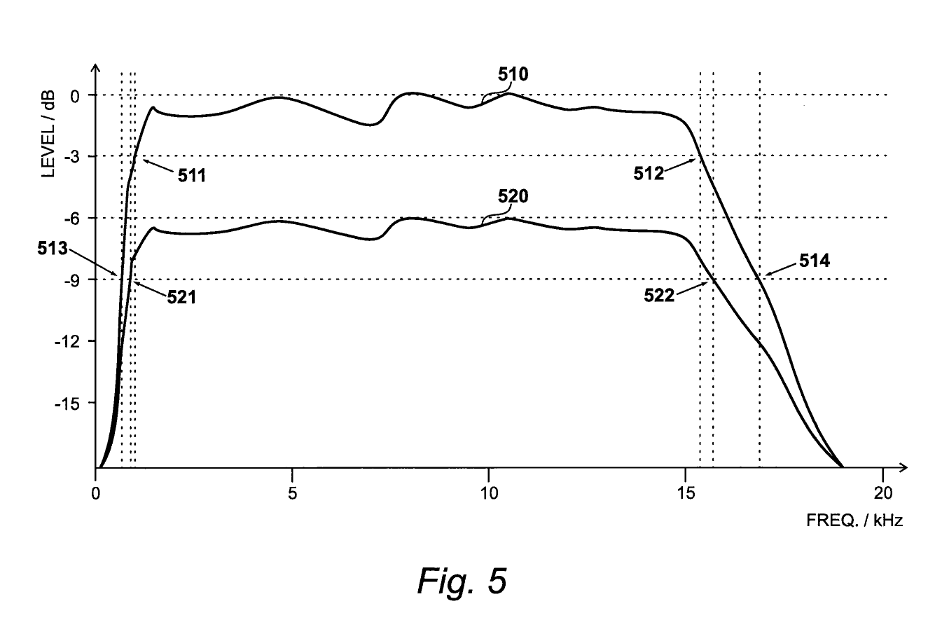

At step 404, a question is asked as to whether the volume level set on the device under test is at a maximum. If answered in the negative, to the effect that the volume level may be increased further, then control returns to step 402 where the next volume level is characterised. If the question asked at step 404 is answered in the affirmative, then recording of test signals at all desired volume levels has been achieved. Control then proceeds to step 405, in which magnitude scaling values are created. This process will be described further with reference to FIGS. 5, 6 and 7.

### FIG. 5

Some results of the analysis of an exemplary loudspeaker's frequency response following the procedures of FIG. 4, are shown in FIG. 5 in the form of a graph.

The sensitivity of the loudspeaker to two different volume levels—maximum volume and half volume—is shown on the graph. A line 510 plots the level of the signal recorded during step 403 when the volume was set at maximum against frequency, whilst a line 520 plots the level of the signal recorded during step 403 when the volume was set at half against frequency. The maximum level of the recording at maximum volume is defined as 0 decibels, reducing down to a noise floor below −15 decibels. As can be seen in the Figure, the maximum level of the recording at half volume is −6 decibels, which is considered to be a normal listening level.

As will be known to those skilled in the art, the bandwidth of a loudspeaker driver is measured between the intersections of the response and the −3 decibel point. Thus, for line 510, the intersections are shown at point 511 and point 512. As can be seen in the Figure, this corresponds to a bandwidth of around 100 hertz to 15.5 kilohertz. Similarly, for line 520, the intersections with its −3 decibel point, at an effective level of −9 decibels, are shown at point 521 and point 522. This corresponds with a bandwidth of around 90 hertz to 16 kilohertz.

As can be seen, however, when the loudspeaker is driven by the amplifier in the device under test at a level of 0 decibels, it is capable of reproducing frequencies between around 50 hertz and 17 kilohertz at the −9 decibel point, illustrated by intersections 513 and 514 with the −9 decibel level respectively. In addition, there is a large enough degree of headroom between these points to give a flat frequency response the whole way across the −6 decibel level. Thus, in actual fact, the loudspeaker is capable, if provided with an appropriately level-corrected signal, of another 40 hertz of bandwidth at the low end and an additional 2 kilohertz of bandwidth at the high end.

Clearly, however, there is little that can be done if a listener decides to choose maximum volume, i.e. a full-scale amplification level, as the selected volume level. Thus, in one embodiment the present invention attempts to begin to correct non-linear frequency response by a loudspeaker when volume levels are selected that are below a full-scale amplification level, so as to still allow a listener freedom to choose their desired volume level. In an alternative embodiment, embedded program control in the playback device may be configured to in artificially limit the maximum volume level such that a substantially flat frequency response is achieved from the minimum to the maximum volume level.

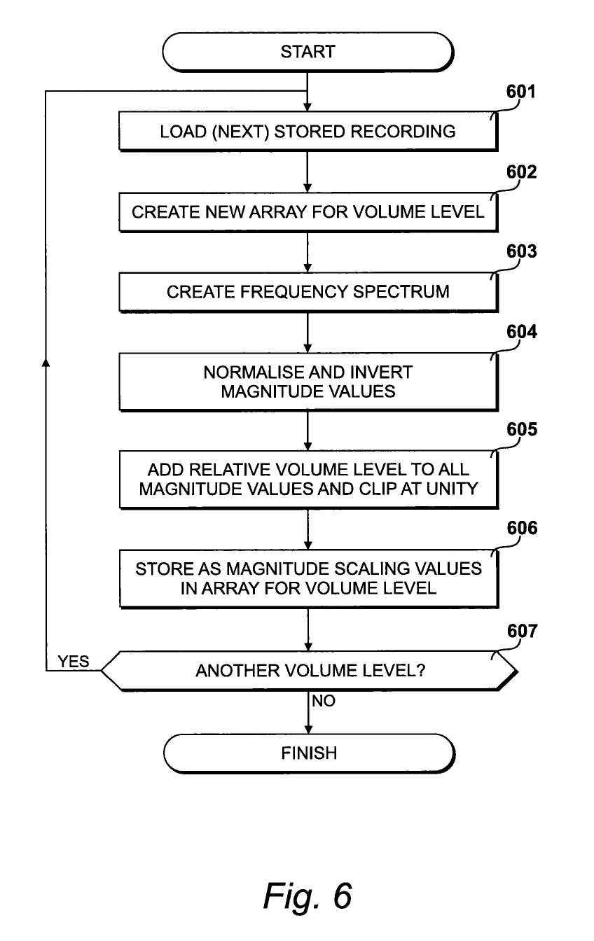

### FIG. 6

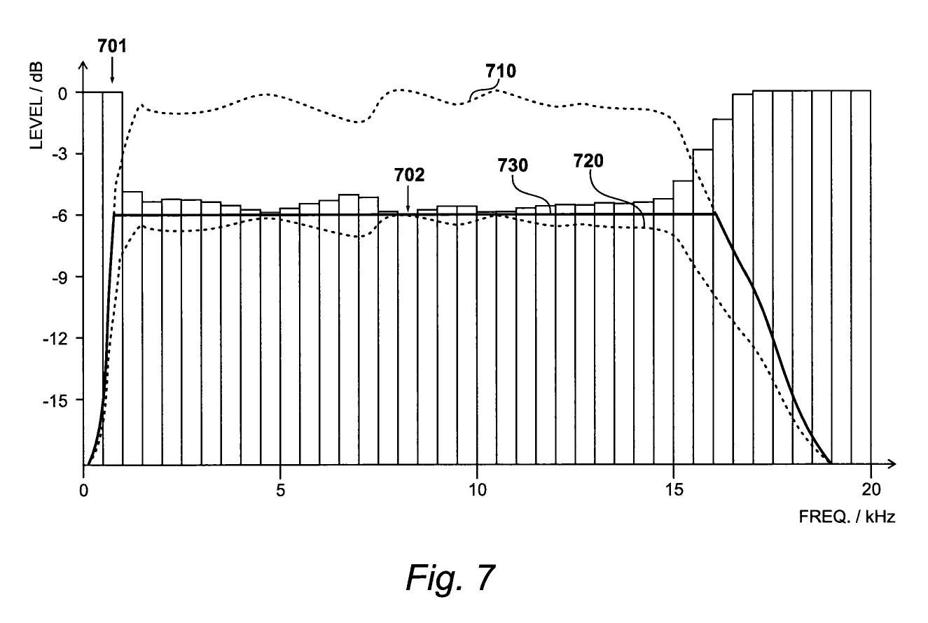

The process of analysing a full set of stored signals recording the sensitivity of the loudspeaker in a device under test in is illustrated in FIG. 7. In an embodiment, the analysis process is performed on workstation 304.

Analysis begins, and at step 601 the first stored recording is loaded, and at step 602 an array is created for the volume level. At step 603, a frequency spectrum is created for the recording, converting the time domain signal into a frequency domain representation. In an embodiment, a Fast Fourier Transform (FFT) is performed on the recording. The size of the FFT is the same as the number of samples making up the recording, which in embodiment is of the order 10⁶. Alternatively, depending upon the precise FFT algorithm, this number may need to be a power of two, say 2²⁰=1048576, in which case the recording may be zero-padded to be of the same length.

As will be known by those skilled in the art, the FFT provides an output comprising a respective complex number encoding magnitude and phase values for each one of a plurality of frequency bins, wherein the number of frequency bins is the same as the length of the time-domain signal taken as the input. Each frequency bin represents a frequency band having a bandwidth and a centre frequency. The magnitude of a particular frequency bin may be obtained by calculating the absolute value of the complex number in the frequency bin.

Thus, at step 604, the magnitude values of each frequency bin are normalised to be between zero and unity, whereafter they are inverted so as to be between negative unity and zero. At step 605, the result of a calculation of the volume level being analysed divided by the maximum volume level, i.e. the relative volume level, is added to each normalised and inverted value. The resulting values are magnitude scaling values, which will correct the non-linear response of the loudspeaker in terms of the magnitude of particular frequency bands. The magnitude scaling values are then stored in the array for the volume level under consideration at step 606.

A question is then asked at step 607 as to whether another volume level needs to be analysed, which, if answered in the affirmative, results in control returning to step 601 in which the next stored recording is processed. Alternatively, the question asked at step 607 is answered in the negative and the creation of magnitude scaling values is complete. Thus, a plurality of arrays is created, each of whose keys are frequency bands and whose values are magnitude scaling values.

### FIG. 7

An array of magnitude scaling values corresponding to a volume level of one half is shown in graphical form in FIG. 8.

The plot shown in the Figure is substantially similar to that shown in FIG. 6, in that the sensitivity of the loudspeaker following testing is shown for maximum volume and half volume by dashed lines 710 and 720 respectively.

The frequency range between 10 hertz and 20 kilohertz has been split up into equally sized bands, corresponding to the frequency bins outputted by the FFT. Each band represents the magnitude scaling value for each frequency for a selected amplification level on the device, which in this case is half volume, corresponding to −6 decibels when compared to maximum volume. As can be seen in the plot, each magnitude scaling value in effect defines a degree of attenuation to apply to each frequency band. The degree of attenuation to apply can be seen to be inversely proportional to the sensitivity of the loudspeaker to particular frequency band. Thus, band 701 will apply 0 decibels of attenuation, in contrast to band 702 which will apply 6 decibels of attenuation. By applying the varying degrees of attenuation to the frequency bands making up the input audio signal, it can be seen that not only a flattening of the resultant frequency response is achieved, but there is an additional benefit of increasing the resultant bandwidth of the reproduced audio, as illustrated by a solid line 730.

### FIG. 8

In addition to magnitude correction, the phase distortion of various frequency bands by a loudspeaker is analysed and corrected. Thus, an exemplary test arrangement for determining the phase response of a device is illustrated in FIG. 8.

Whilst it is possible to determine the phase response of a device by analysing sampled audio in a similar way to which the present invention determines a loudspeaker's sensitivity, the present applicant has determined that improved characterisation can be carried out electrically. Thus, along with a device under test 801, the arrangement in the Figure includes a signal generator 802, a measurement circuit 803 and a data logger 804.

In this example, signal generator 802 supplies a series of test signals via a positive terminal 805 and a negative terminal 806. These enter measurement circuit 803 via a positive terminal 807 and a negative terminal 808. Positive terminal 807 is connected directly to the device under test, whilst negative terminal 808 is connected to a positive terminal 809 of data logger 804. A reference terminal 810 of data logger 804 is connected to the device under test. A resistor 811 is placed across positive terminal 809 and reference terminal 810. Thus, data logger 804 measures the voltage drop across the resistor, resulting in the logging of data indicative of the phase shift of a test signal produced by signal generator 802 caused by the entirety of the electrical system within device under test 801.

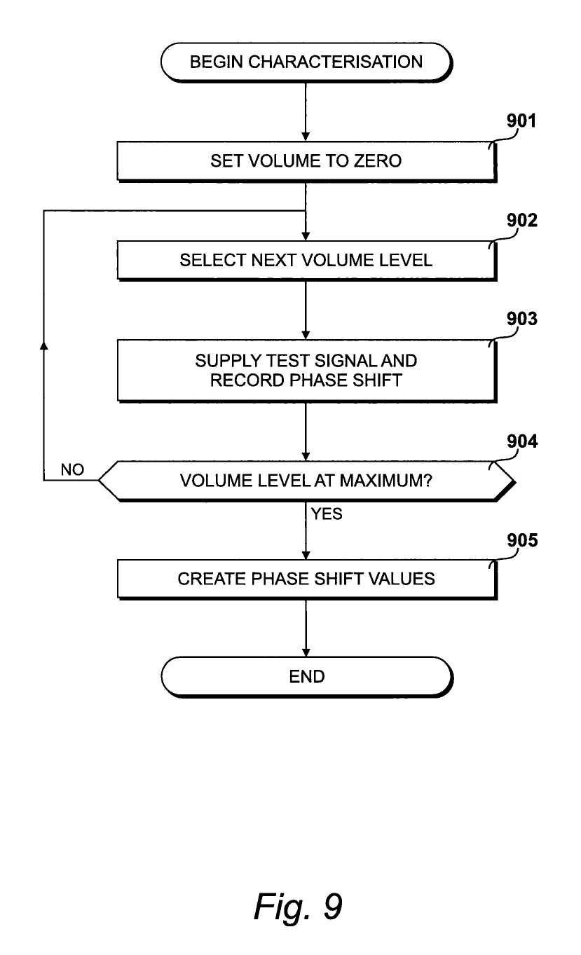

### FIG. 9

An overview of procedures undertaken to characterise the phase response of a device under test in the environment illustrated in FIG. 8, is shown in FIG. 9.

The characterisation process begins, and at step 901 the volume level of the device under test is set to zero. At step 902, a loop begins in which the next volume level is firstly selected. In the context of the present invention, the volume setting of a device under test will be understood by those skilled in the art to mean the gain (or attenuation, if viewed from another perspective) of the input audio signal when being amplified. In a similar way to the procedures described previously with reference to FIG. 4, every possible volume level that a device may be set to is used during the characterisation process. Alternatively, only a subset of every possible volume level is tested.

At step 903, a test signal is supplied to the device, at which time the data logger 804 logs data indicative of the phase shift caused by the device under test when compared to the reference test signal. In an embodiment, the test signal supplied to the device is a sinusoidal frequency sweep, as described previously with reference to FIG. 4.

Thus, the result of performing step 903 is a recording of the device under test's shifting of the phase of a plurality of frequencies at a particular volume level.

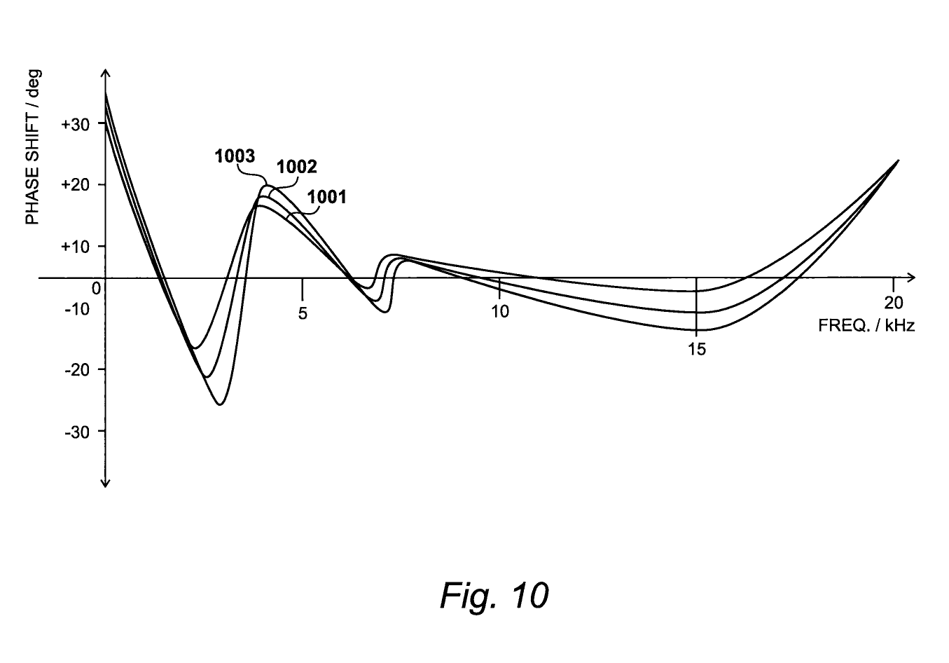

At step 904, a question is asked as to whether the volume level set on the device under test is at a maximum. If answered in the negative, to the effect that the volume level may be increased further, then control returns to step 902 where the next volume level is characterised. If the question asked at step 904 is answered in the negative, then recording of test signals at all desired volume levels has been achieved. Control then proceeds to step 905, in which phase shift values are created. This process will be described further with reference to FIGS. 10, 11 and 12.

### FIG. 10

The results of the analysis of a device under test's phase response at some volume levels following the procedures of FIG. 9, is shown in FIG. 10.

As can be seen, compared to a reference zero phase shift, the device under test in this example introduces different phase shifts at different volume levels. Thus, on the plot, line 1001 corresponds to a first volume level, line 1002 corresponds to a second volume level, and line 1203 corresponds to a third volume level.

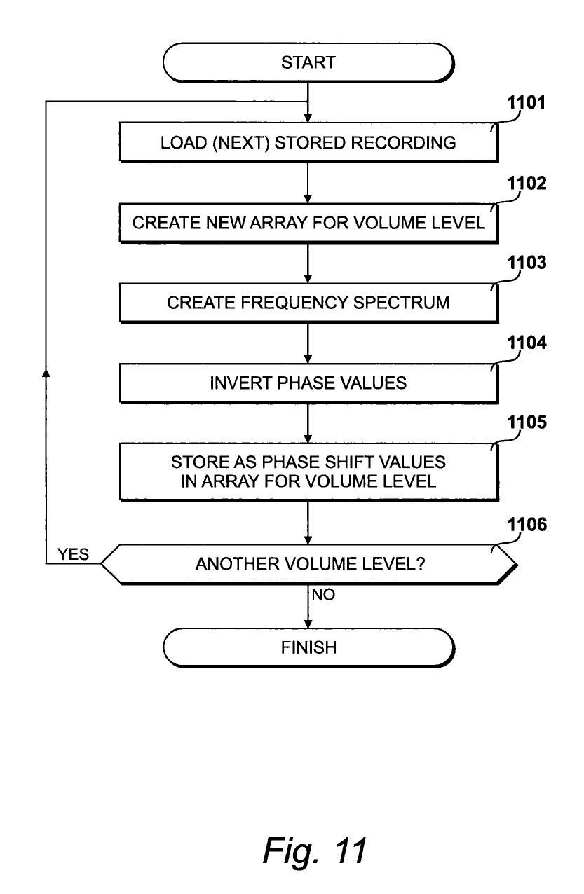

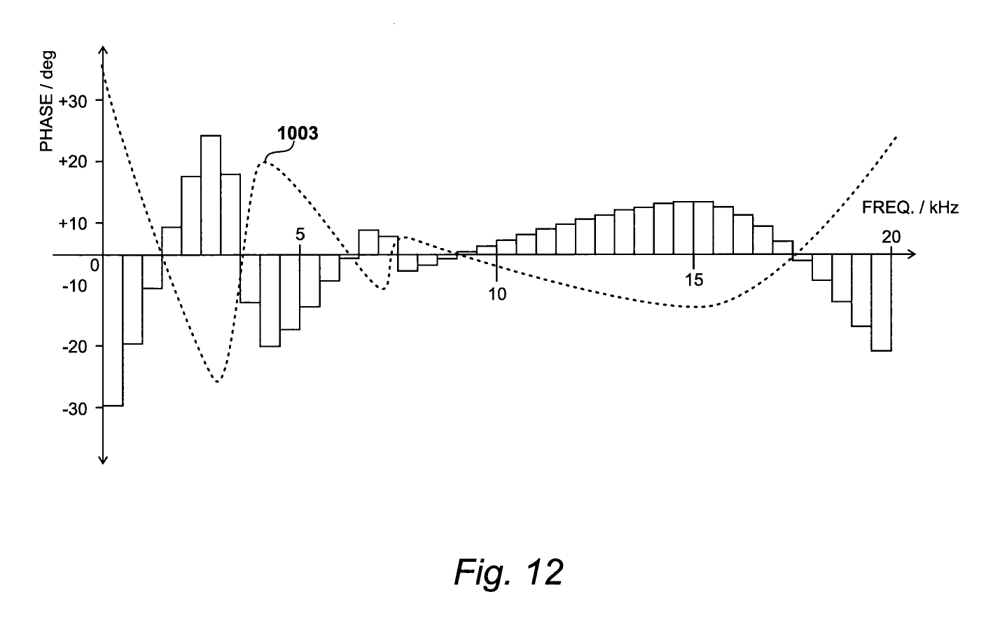

It may be noted that at very low frequencies and very high frequencies, the rate of change of the phase shift with respect to frequency is high. This results in markedly different phase shifts occurring to frequencies that are in reality quite close to one another. This large differential in terms of phase shifts between neighbouring frequencies is one of the root causes of the frequency response rolloff of loudspeakers, as destructive interference of sound waves occurs due to phase incoherence of these frequencies. Thus, the present invention corrects for these phase distortions, such that by the time the loudspeaker has reproduced the audio signal it has the same phase characteristics as the source. As will be described with reference to FIGS. 11 and 12, the present invention achieves this by purposefully not being linear phase or even minimum phase in its processing—approaches which previously have been thought to be absolutely necessary for high quality audio reproduction. It is due to the phase distortions introduced by the loudspeaker which guarantee that, even if processing is linear phase before it reaches the loudspeaker, phase distortion is bound to occur.

### FIG. 11

The process of analysing a full set of stored signals recording the phase response of the loudspeaker in a device under test in is illustrated in FIG. 11. In an embodiment, the analysis process is performed on workstation 304, following the downloading of data logs from data logger 804.

Analysis begins, and at step 1101 the first stored recording is loaded, and at step 1102 an array is created for the volume level. At step 1103, a frequency spectrum is created for the recording, converting the time domain signal into a frequency domain representation. As described previously with reference to FIG. 6, the frequency spectrum can be created using an FFT, whose output is a respective complex number encoding the phase and magnitude values for each one of a plurality of frequency bins. The phase value of a particular frequency bin may be obtained by calculating the argument of the complex number for the frequency bin.

Thus, at step 1104, the phase values of each frequency bin are inverted, i.e. multiplied by negative one. The resulting values are phase shift values, which will correct the non-linear response of the loudspeaker in terms of the phase of particular frequency bands. The phase shift values are then stored in the array for the volume level under consideration at step 1105.

A question is then asked at step 1106 as to whether another volume level needs to be analysed, which, if answered in the affirmative, results in control returning to step 1101 in which the next stored recording is processed. Alternatively, the question asked at step 1106 is answered in the negative and the creation of phase shift values is complete. Thus, a plurality of arrays is created, each of whose keys are frequency bands and whose values are phase shift values.

### FIG. 12

An array of phase shift values corresponding to the third volume level discussed with reference to FIG. 10, is shown in graphical form in FIG. 8.

Line 1003 is shown, which shows the phase shift of frequencies at the third volume level. Phase shift values are also illustrated by bars corresponding to various discrete frequency bands, describing the amount by which the phase of frequencies should be adjusted up or down. By shifting the phase of frequency bands in an audio signal by these phase correction values, the present invention negates the effect of phase distortion by an audio reproduction device.

### FIG. 13

Following the characterisation of a device and its loudspeaker in order to arrive at magnitude scaling values and phase shift values, an embodiment of the present invention includes a process of converting these values to enable faster real-time processing by, for example, a digital signal processor. Such a conversion process is illustrated in FIG. 13.

Conversion begins, and at step 1301 a new lookup table is created for a first volume level. The lookup table is configured to accept a frequency band index as its input, and will return a correction coefficient specific to the volume level.

Control proceeds to step 1302, whereupon a new entry is made in the lookup table for a frequency band. At step 1303, the magnitude scaling value and phase shift value for the frequency band under consideration are retrieved from their respective arrays (generated during steps 405 and 1105 respectively). As an example, a volume level of 50 (out of a maximum of 100) and the sixth frequency band may be being considered in this procedure, with an associated magnitude scaling value of 0.8 and an associated phase shift value of 15 degrees.

It will be appreciated by those skilled in the art that, should the magnitude and phase values of a particular frequency band be expressed as a complex number, then a scaling of the magnitude and shifting of the phase of the frequency band may be implemented by multiplication by another complex number whose magnitude is the magnitude scaling value and whose argument is the phase shift value—a complex magnitude and phase correction coefficient.

To derive such a complex magnitude and phase correction coefficient, then at step 1304, the magnitude scaling and phase shift values are considered as the magnitude r and phase φ of a complex number expressed in polar form z=re^{iφ} (where φ is base of the natural logarithm and j is the imaginary unit). For storage in the lookup table created during step 1301, conversion to rectangular form z=x+jy takes place (using the identity x=r cos φ and y=r sin φ).

Using the exemplary values above of the magnitude r=0.8 and the phase φ=15 degrees (or π÷12 radians), then we arrive at a complex correction coefficient of 0.772+0.259j.

This complex number is then stored in the lookup table at step 1305. At step 1306, a question is asked as to whether another frequency band needs to be considered, and if so control returns to step 1302. Alternatively, a question is asked as to whether another volume level needs to be considered, and if so control returns to step 1301. If either of the questions asked at step 1306 and 1307 are answered in the negative then the process of creating a lookup table for each volume level is complete.

As described previously with reference to FIGS. 6 and 9, a frequency spectrum can, in an embodiment, be made having of the order of 10⁶ individual frequency bands. The properties of the FFT mean that, for a frequency spectrum to be produced with that order of frequency bands, a time domain signal having that order of samples must be used. This can either be achieved by using a very large frame size, and, in the case of streaming audio, waiting a long time for the stream to buffer and thereby increasing latency, or by zero-padding a frame and thereby increasing computation time for no increase in spectral resolution.

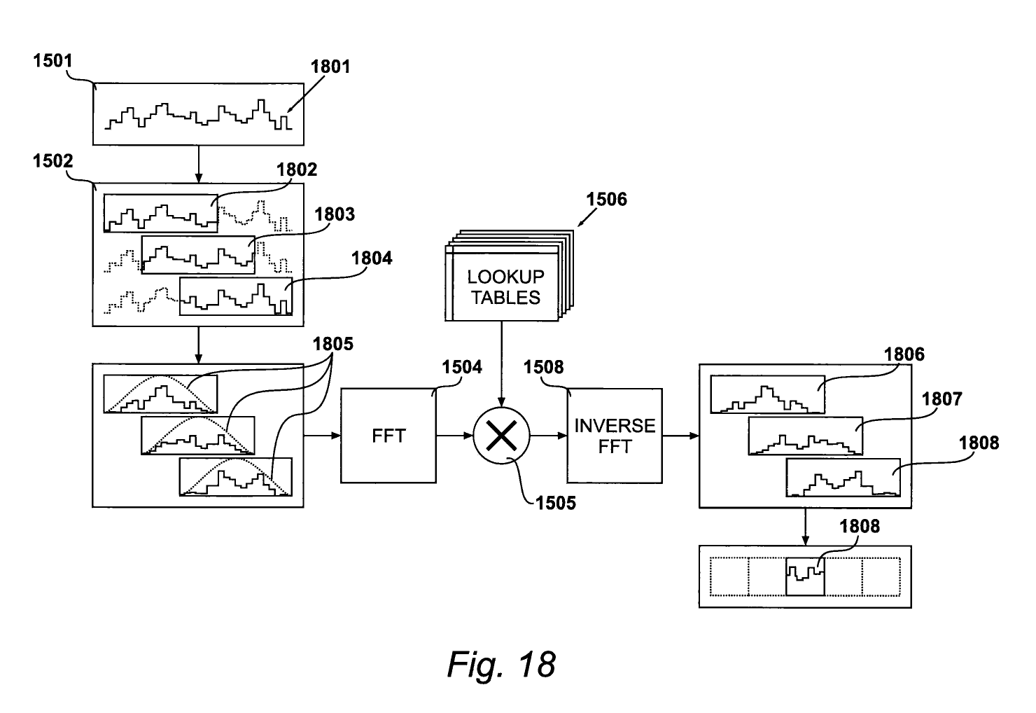

Thus, following the creation of the lookup tables, downsampling may be performed on them to give downsampled lookup tables having complex correction coefficients stored therein corresponding to, say, of the order of 10³ frequency bands. In an example, the lookup tables are downsampled to contain complex corrections coefficients for 1024 frequency bands. As will be described further with reference to FIG. 18, this has the effect of ensuring that the lookup tables are as accurate as possible, but reduces latency when processing an audio signal.

It is important to note that lookup tables may also be constructed not solely for magnitude and phase correction, but to enable the application of other effects such as equalisation in order to emphasise certain instruments or voices, or to eliminate feedback, custom loudness curves, or even simple effects such as bass boost.

### Signal Processing Implementation

The current embodiment of the present invention makes use of the signal processing capability found in many audio reproduction devices to apply the correction coefficients to an audio signal. The steps carried out can be summarised as receiving an input audio stream; generating a frequency spectrum of at least a portion of the input audio stream, in which the frequency spectrum defines magnitude and phase values for each of a number of frequency bands; and adjusting the magnitude and phase values to counteract the effect of the non-linear frequency response of the loudspeaker.

### FIG. 14

An exemplary configuration of a signal processor 1401 for implementing the processing requirements of the present invention is shown in FIG. 14.

An input interface 1402 is configured to receive an input audio signal and provide it to a processing bus 1403. Connected to processing bus 1403 is an analogue-to-digital converter (ADC) 1404 and a digital-to-analogue-converter (DAC) 1405. In addition, a microcontroller 1406 and a digital signal processor (DSP) 1407 are also connected to processing bus 1403. DSP 1407 acts as a co-processor to microcontroller 1406, as for certain tasks, such as mathematical operations, it provides increased performance. Such a combination of a microcontroller and a digital signal processor is sometimes referred to in the art as a “digital signal controller”.

Each component communicates over processing bus 1403, therefore allowing the sharing of information. Microcontroller 1406 also includes a data interface 1410, over which program instructions (illustrated as 1411) may be conveyed and then stored in storage device embodied by a ROM module 1408 and executed by microcontroller 1406 in cooperation with DSP 1407. ROM module may in an embodiment be E²PROM (Electrically Erasable Programmable Read-Only Memory) so as to allow updating of program instructions etc. ROM 1408 also stores the look up tables storing the magnitude and phase correction coefficients creating as previously described with reference to FIG. 13.

If the input audio signal provided to input interface 1402 is an analogue signal, ADC 1404 will sample it in order to provide a digital signal to microcontroller 1406 and DSP 1407. In this embodiment, ADC 1404 and DAC 1405 are 16-bit, 44.1 KHz components, but if a higher quality conversion is required, processing apparatus 1401 could include 24-bit, 96 KHz parts instead.

Following processing of the input audio signal by microcontroller 1406 and DSP 1407, the resulting processed signal is either converted into an analogue signal by DAC 1405 and provided to an output interface 1409 for amplification, or, if the amplifier present in the device is a suitable amplifier (operating in switched or Class D mode, as described previously), then the digital processed signal can be provided to output interface 1409.

Microcontroller 1406 also has a volume control interface 1410, which is adapted to receive a signal indicative of a selected volume level of the input audio signal, and can therefore process the input audio signal in dependence upon the volume level selected in the particular device in which processing apparatus 1401 is present.

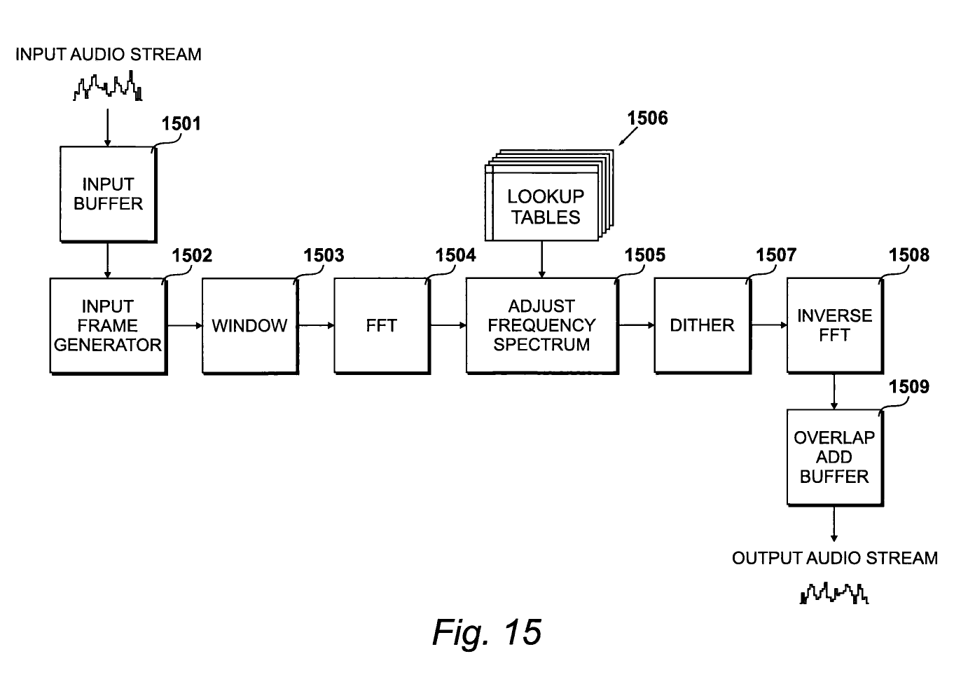

### FIG. 15

A block diagram illustrating processing modules employed by the present invention to achieve its signal processing requirements is shown in FIG. 15. The processing takes place upon a stream of digital samples of the input audio signal in real-time.

An input audio stream is received, which in this example is a monoaural pulse code modulated (PCM) audio stream having a sampling frequency of 44.1 kilohertz and a bit depth of 16 bits. An input buffer 1501 buffers the samples as they are received. In a specific embodiment, the input buffer is a first-in-first-out buffer, implemented by a circular buffer.

An input frame generator 1502 reads samples from the input buffer to create input frames, each comprising a number of samples. As will be explained further, the creation of input frames imposes a latency on the processing of an input audio stream. The more samples in an input frame, the more accurate correction may take place, but with the trade-off that latency increases proportionally.

Thus, in one embodiment, the input frames are composed of 512 samples, or in another embodiment are composed of 1024 samples. The input frames are created with a degree of overlap as the audio stream enters the buffer. The degree of overlap is dependent upon the number of samples that are contained in an input frame, so for 512 samples, the input frames have an 87.5 percent overlap, and for 1024 they have a 75 percent overlap.

Considering the 512 samples per input frame example, then an incoming audio stream clocked at 44.1 kilohertz results in a first frame being created after 11.6 milliseconds, with subsequent frames then being created every 1.5 milliseconds.

In the embodiment shown in FIG. 15, the input frame generator supplies input frames to a window function multiplier 1503, which applies a window function to the input frames prior to them being supplied to a Fast Fourier transform processor 1504. As will be appreciated by those skilled in the art, windowing is important to reduce spectral leakage through the frequency spectrum. The point at which windowing can take place is variable: it may be done fully prior to the FFT, it may be done fully following an inverse FFT, or half may be performed before and half after. In the present embodiment, all windowing is performed prior to performing the FFT. The window function itself is, in an embodiment, a Hann window function. In a specific embodiment, an approximation to the Hann window function adapted for constant-overlap-add is used, so as to avoid amplitude modulation of the output audio stream. Alternative window functions and their derivatives may be used instead, such as the Hamming or Blackman windows. In any event, use of a constant-overlap-add window results in a constant amplitude when the output audio stream is created.

The Fourier transform processor 1504 implements a Fourier transform so as to create a frequency spectrum of an input frame. Alternative embodiments of the present invention may use alternative techniques to create a frequency spectrum, though, such as the Modified Discrete Fourier Transform. The frequency spectrum is represented by an array of complex numbers, each representing a particular frequency band, or “bin”. The end frequency of each frequency bin, and accordingly its width due to the linearity of the FFT, is determined by the number of points specified for the FFT. The number of points of the FFT is, preferably, the same as the number of samples in the input frames, so as to avoid zero-padding. Thus, in an embodiment, a 512-point FFT is used. This results in 512 frequency bins being created, with a fundamental FFT frequency of approximately 86 hertz for a 44.1 kilohertz audio stream.

An adjustment block 1505 is provided which takes the frequency spectrum and applies a degree of adjustment to it. The adjustment block takes the form of a multiplier (possibly a multiply-accumulate unit) when the present invention is implemented on a digital signal processor. The adjustment of the frequency spectrum is achieved by, on a per-frequency bin basis, multiplying the complex number defining its magnitude and phase by a magnitude and phase correction coefficient obtained from one of the lookup tables (illustrated at 1506) stored in ROM 1408.

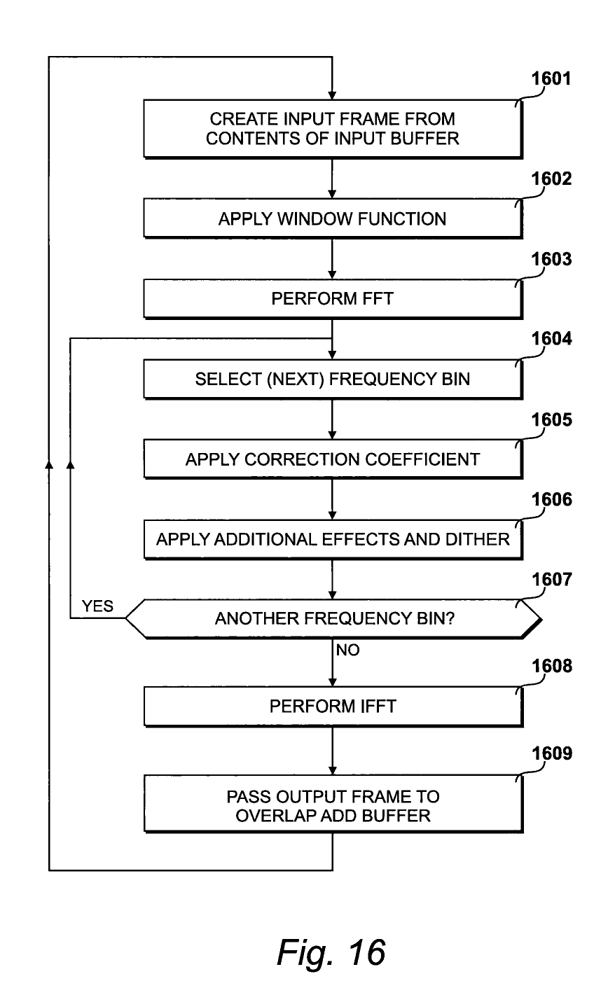

In an embodiment, the magnitude and phase correction coefficients to apply to each frequency bin are all obtained from the same lookup table, corresponding to the current volume level of the playback device. A sequence of procedures used to implement this approach will be described further with reference to FIG. 16.

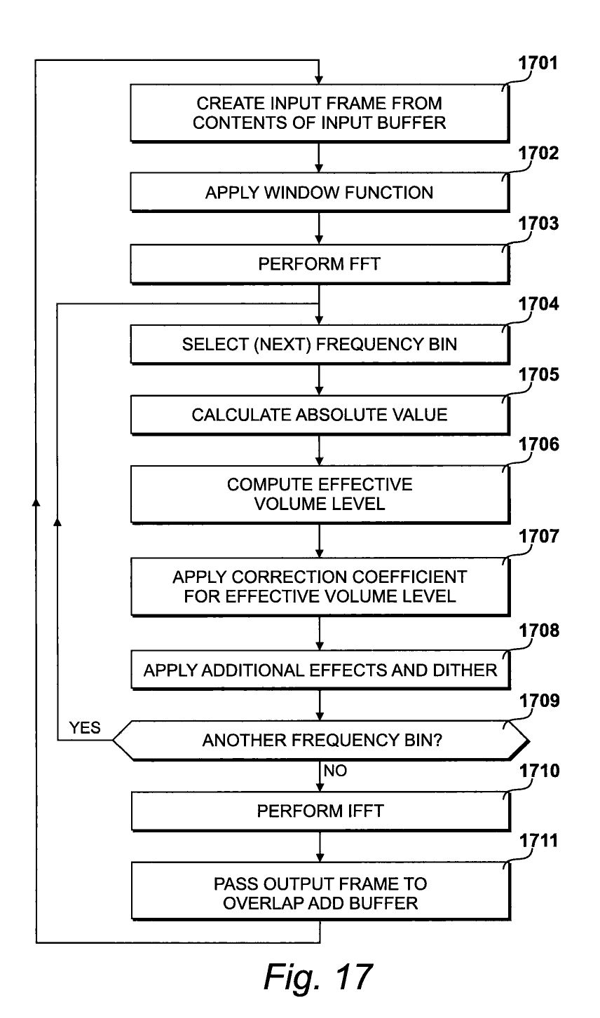

In an alternative embodiment, the magnitude and phase correction coefficients to apply to each frequency bin are each obtained the lookup table, corresponding to the effective volume level of the particular frequency band on the playback device. This has the effect of correcting for the actual level at which a frequency component will be reproduced, and so does not overcorrect when a particular frequency is quieter than others, for example. A sequence of procedures used to implement and control this approach will be described further with reference to FIG. 17.

In another embodiment, and as described previously, additional lookup tables are provided to enable the adjustment of frequency spectra so as to achieve further effects. The coefficients in these lookup tables may then be applied by adjustment block 1505 following application of the magnitude and phase correction coefficients.

Following the appropriate adjustment of the frequency spectrum, one specific embodiment of the present invention provides for dither to be added by a dither generator 1507. It is important to note that the dither generator 1507 adds dither in the frequency domain, and not in the time domain as a noise shaper might. The dither generator corrects for predictable rounding errors introduced in the digital signal processor, which create a form of quantization noise. In an embodiment, the dither generator adds dither at a level of 30 percent of the quantization noise. Additionally, in the present embodiment, the amount of dither is correlated between the amplitude and phase in each frequency bin. In other embodiments the amount of dither could be de-correlated, that is to say the degree of dither applied to the magnitude of a complex number in a frequency bin (representing amplitude) could be different to that applied to the argument of a complex number in a frequency bin (representing phase).

Following the frequency domain processing, an inverse Fourier transform processor 1508 performs an inverse Fourier transform on each of the frequency spectra to produce output frames. The output frames are then supplied to an overlap add buffer, which in effect reverses the process of input frame generator 1502 creating input frames from input buffer 1501. The output frames are added to one another with the same degree of overlap as that with which they were created, so as to produce an output audio stream.

The output audio stream may then be directly sent to an amplifier following a possible process of conversion from a pulse code modulated (PCM) signal to a pulse width modulated (PWM) signal or a pulse density modulated (PDM) signal (if switching or Class D) or converted into an analogue signal by DAC 1405 whereafter it is supplied to an amplifier (if analogue).

It will be appreciated by those skilled in the art that moving from processing a monoaural PCM stream to processing a stereo PCM stream may be achieved using the same processing foundation as described above. Processing may be done for each channel in parallel if a multi-core digital signal processor is used, or an alternation of the channel being processed may be made.

### FIG. 16

As described previously, in one embodiment of the present invention, magnitude and phase correction coefficients used in the adjustment block 1505 during signal processing are all selected from the same lookup table. An exemplary digital signal processing procedure to process an input audio stream is illustrated in FIG. 16.

At step 1601 an input frame is created from the contents of the input buffer 1501. At step 1602, an appropriate window function is applied to the input frame, suitable for constant overlap add processing. At step 1603, a Fast Fourier Transform is performed on the windowed input frame. A loop begins with step 1604, in which, to begin with, a first frequency bin (the FFT fundamental) is selected. The magnitude and phase correction coefficient is then applied at step 1605, obtained from the lookup table corresponding to the selected volume level. Any additional effects, such as custom equalisation curves or bass boost described previously with reference to FIG. 13, may be added at step 1606 along with the addition of dither by dither generator 1507.

At step 1607, a question is asked as to whether another frequency bin needs adjusting. If so, the control returns to step 1604 whereupon the next frequency bin is selected. If all frequency bins have been adjusted, then control proceeds to step 1608 in which an inverse Fast Fourier Transform is performed on the frame, to produce an output frame. The output frame is then passed to the overlap add buffer at step 1609 for generating the output audio stream.

Of course, the above procedure can be seen to be merely exemplary. The loop could be implemented in a pipelined fashion or operations on each frequency bin could occur in parallel depending upon the hardware optimisations available.

### FIG. 17

In another embodiment of the present invention, magnitude and phase correction coefficients used in the adjustment block 1505 during signal processing are selected on a per-bin basis, in dependence upon what the effective reproduction level of the bin will be. An exemplary digital signal processing procedure to process an input audio stream in this way is illustrated in FIG. 17.

At step 1701 an input frame is created from the contents of the input buffer 1501. At step 1702, an appropriate window function is applied to the input frame, suitable for constant overlap add processing. At step 1703, a Fast Fourier Transform is performed on the windowed input frame. A loop begins with step 1704, in which, to begin with, a first frequency bin (the FFT fundamental) is selected.

The value of the selected frequency bin, being a complex number in rectangular form, does not immediately give away much meaningful data as to what the amplitude of the frequency bin is. Thus, at step 1705, the absolute value of the value of the frequency bin is calculated, possibly by taking the square root of the sum of the squares of its real and imaginary parts. Alternatively, the absolute value can be obtained by use of a magnitude estimation algorithm, a dedicated look up table or using CORDIC (COordinate Rotation Digital Computer) methods.

At step 1706, the effective volume level of the bin is computed by scaling the actual selected volume level by a value representing the relative intensity of the frequency bin. This relative intensity is calculated by dividing the actual magnitude of the bin, obtained during step 1705, by the maximum magnitude value that may be taken by a frequency bin in the FFT routine employed in step 1704. This is desirable as a first frequency bin in a first frame having half the magnitude of corresponding second frequency bin in a second frame will only excite a loudspeaker with half the intensity. Thus, it may be possible for over-correction to occur should no compensation be made for this, leading to unwanted distortion.

Thus, this step takes into account the fact that, for instance, a very subtle, quiet piece of music may be being played, requiring the selection of a high volume level, possibly approaching maximum volume. However, when reproduced by a loudspeaker, the signal supplied to the loudspeaker following amplification may only result in the levels of magnitude and phase distortions that would occur when a very loud piece of music with a low selected volume level is supplied. In effect, therefore, the calculation made during step 1706 is one of predicting the resultant sound pressure level that the frequency bin under consideration will cause.

An alternative method of deriving the relative intensity of the frequency bin involves comparing the levels of all bins in the frequency spectrum, giving a relative intensity between zero and unity. This value may then be used to scale the actual selected volume level.

In a specific embodiment of the present invention, a degree of damping is applied to limit the rate of change of the effective volume level, akin to a ballistics system employed in audio metering. Thus, the maximum excursion of the value for the effective volume level for the frequency bin is limited with respect to its historic values. The damping applied in one embodiment is similar to an attack-sustain-release envelope, of the type commonly employed in synthesisers. This has the advantage of reducing possible sudden changes in the resulting output audio stream, which may manifest themselves as clicks or cracks due to aggressive effective alteration of the level of the output PCM stream.

The magnitude and phase correction coefficient obtained from the lookup table corresponding to the effective volume level of the bin is then applied at step 1707. Any additional effects, such as custom equalisation curves or bass boost described previously with reference to FIG. 13, may be added at step 1708, along with the addition of dither by dither generator 1507.

At step 1709, a question is asked as to whether another frequency bin needs adjusting. If so, the control returns to step 1704 whereupon the next frequency bin is selected. If all frequency bins have been adjusted, then control proceeds to step 1710 in which an inverse Fast Fourier Transform is performed on the frame, to produce an output frame. The output frame is then passed to the overlap add buffer at step 1711 for generating the output audio stream.

### FIG. 18

A high-level graphical representation of the processing of a number of input frames derived from an input audio stream is shown in FIG. 18.

A portion of an input audio stream 1801 is shown being buffered by input buffer 1501. The input frame generator 1502 generates input frames from the contents of the buffer, with a first input frame 1802, a second input frame 1803 and a third input frame 1804 being shown in the Figure. As can be seen, the first input frames has a degree of overlap with the subsequent input frames, as previously described with reference to FIG. 15. It will be appreciated that the degree of overlap shown in FIG. 18 is merely exemplary and for ease of illustration, and the percentage overlap between input frames is dependent upon the number of samples they contain.

Following the generation of input frames, window function multiplier 1503 applies a constant-overlap-add window function 1805 to input frames 1802, 1803 and 1804. The windowed input frames are then each subjected to an FFT by Fourier transform processor 1504 to create frequency spectra defining magnitude and phase values for a plurality of frequency bands. The frequency spectra are then adjusted by adjustment block 1505, taking the form of a multiplier in this example. The magnitude and phase correction coefficients are obtained from lookup tables 1506.

The adjustment block 1505 may also add other effects at this point. Dither generated by dither generator 1507 may in an embodiment be added to the frequency spectra as described previously with reference to FIG. 15, after which the frequency spectra are subjected to an inverse FFT by inverse Fourier transform processor 1508. The resulting output frames, first output frame 1806, second output frame 1807 and third output frame 1808 are then added together by overlap add buffer 1509 to create the output audio stream. The overlapping portions of the three output frames create a block of output audio 1809 that is the sum of the three overlapping portions of the output frames. This process occurs continuously so as to create a seamless output audio stream.

What we claim is:

1. A method of processing an audio signal to correct the non-linear frequency response of a loudspeaker, the method comprising steps of:
receiving an audio signal as an input audio stream comprising digital samples;
generating an input frame from the input audio stream, comprising a plurality of said digital samples;
performing a Fourier transform on the input frame, thereby creating a frequency spectrum defining magnitude and phase values for a plurality of frequency bands;
adjusting the frequency spectrum by scaling the magnitude and phase values of each of the plurality of frequency bands by a magnitude and phase correction coefficient;
performing an inverse Fourier transform on the adjusted frequency spectrum to create an output frame;
outputting the output frame as part of an output audio stream.

2. The method of claim 1, further comprising a step of applying a windowing function to the input frame prior to performing the Fourier transform.

3. The method of claim 1, wherein the magnitude and phase correction coefficient for a particular frequency band is defined in a lookup table.

4. The method of claim 3, wherein:
a plurality of lookup tables are available, each one of which corresponds to a possible volume level for the audio signal, and
the magnitude and phase correction coefficient for each frequency band is selected from the lookup table corresponding to a selected volume level for the audio signal.

5. The method of claim 3, wherein:
a plurality of lookup tables are available, each one of which corresponds to a possible volume level for the audio signal, and
the magnitude and phase correction coefficient for each frequency band is selected from the lookup table corresponding to an effective volume level for the audio signal, wherein the effective volume level is derived by scaling the selected volume level by the magnitude of the frequency band being adjusted.

6. The method of claim 1, wherein the outputting step involves combining a plurality of output frames using an overlap add procedure to create the output audio stream.

7. The method of claim 1, further comprising a step of applying a degree of dither to the magnitude and phase values in the frequency spectrum.

8. The method of claim 1, wherein the magnitude and phase correction coefficients flatten the frequency response of the loudspeaker.

9. The method of claim 1, wherein the magnitude and phase correction coefficients extend the effective bandwidth of the loudspeaker.

10. A non-transitory computer-readable medium encoded with computer-readable instructions that, when executed by a computer, cause the computer to perform a method of processing an audio signal to correct the non-linear frequency response of a loudspeaker, the method comprising steps of:
receiving an audio signal as an input audio stream comprising digital samples;
generating an input frame from the input audio stream, comprising a plurality of said digital samples;
performing a Fourier transform on the input frame, thereby creating a frequency spectrum defining magnitude and phase values for a plurality of frequency bands;
adjusting the frequency spectrum by scaling the magnitude and phase values of each of the plurality of frequency bands by a magnitude and phase correction coefficient;
performing an inverse Fourier transform on the adjusted frequency spectrum to create an output frame;
outputting the output frame as part of an output audio stream.

11. An apparatus for correcting the anticipated distortion of an audio signal by a loudspeaker having a non-linear frequency response, the apparatus comprising:
an input frame generator, configured to receive an input audio stream comprising digital samples and generate input frames each comprising a plurality of samples;
a Fourier transform processor configured to subject each of said input frames to a Fourier transform, thereby creating frequency spectra of the input frames, each frequency spectrum defining the magnitude and phase values of each of a plurality of frequency bands;
a storage device having stored therein a set of magnitude and phase correction coefficients, each one of which corresponds to one of the plurality of frequency bands;
a multiplier configured to scale the magnitude and phase values of each frequency band in each of the frequency spectra by the corresponding magnitude and phase correction coefficient;
an inverse Fourier transform processor configured to perform an inverse Fourier transform on the output of the multiplier to create output frames; and
an output frame combiner configured to combine said output frames to generate an output audio stream.

12. The apparatus of claim 11, wherein the magnitude and phase correction coefficients flatten the frequency response of the loudspeaker.

13. The apparatus of claim 11, wherein the magnitude and phase correction coefficients extend the effective bandwidth of the loudspeaker

14. The apparatus of claim 11, wherein the input frame generator generates input frames that each have a degree of overlap with at least one preceding frame, and is configured to apply a constant-overlap-add windowing function to the input frames.

15. The apparatus of claim 11, further comprising a volume control interface adapted to receive an indication of a selected one of a plurality of possible volume levels for the reproduction of the audio signal, and wherein the storage device has stored therein a plurality of sets of magnitude and phase correction coefficients, one for each possible volume level.

16. The apparatus of claim 15, wherein, for all frequency bands in its scaling process, the multiplier is configured to use the set of magnitude and phase correction coefficients corresponding to the selected volume level.

17. The apparatus of claim 15, wherein, for each frequency band in its scaling process, the multiplier is configured to use the set of magnitude and phase correction coefficients corresponding to an effective volume level, wherein the effective volume level is derived by scaling the selected volume level by the magnitude of the frequency band being scaled.

18. The apparatus of claim 11, further comprising a dither generator configured to apply a degree of dither to each frequency band that is output by the multiplier prior to the creation of an output frame.

19. The apparatus of claim 11, further comprising an analog to digital converter configured to convert the output audio stream to an output analog signal, an amplifier configured to amplify the output analog signal to provide an amplified signal.

20. The audio processing apparatus of claim 11, forming part of any one of:
a television;
a sound bar;
a personal media player docking station;
a tablet computer;
a mobile telephone;
a personal computer; or
a high-fidelity stereo system.
